(19) United States
(12) Patent Application Publication
(10) Pub. No.: US 2013/0001052 A1
(43) Pub. Date: Jan. 3, 2013

(54) MECHANICAL INTERLOCK SOCKET OUTLET

(75) Inventor: JOHN KANTOR, Hobe Sound, FL (US)

(73) Assignee: ERO, Inc., Riviera Beach, FL (US)

(21) Appl. No.: 13/491,193

(22) Filed: Jun. 7, 2012

Related U.S. Application Data
(60) Provisional application No. 61/494,750, filed on Jun. 8, 2011.

(51) Int. Cl. H01H 21/02

(52) U.S. Cl. 200/43.02

(57) ABSTRACT

A mechanical interlock socket outlet includes a female receptacle mounted to a face plate, a breaker box, a toggle switch for activating the breaker box, and an actuating rod for operating the toggle switch. A locking arm is provided for engaging the actuating rod and has a first position and a second position. A safety release saddle plate is engaged to the actuating rod. The plate has a locking arm release portion such that movement of the plate will contact the locking arm and move the locking arm from the first to a second position. Springs are connected between the plate and the face plate, and connected to a portion of the saddle plate adjacent a top portion of the plate. The springs act to return the saddle plate and toggle switch to a locked position. A push pin is provided to move the saddle plate.

### CROSS REFERENCE TO RELATED APPLICATIONS

This Application claims priority to U.S. Provisional Application No. 61/494,750, filed Jun. 8, 2011, entitled Mechanical Interlock Socket Outlet, the entirety of which is incorporated herein by reference.

### FIELD OF THE INVENTION

This invention relates to refrigerated containers, and more particularly to interlock units for reefer power connections.

### BACKGROUND

Mechanical interlock socket outlets are used worldwide in the shipping industry for refrigerated containers or “reefers.” The function of such outlets beyond giving power to the reefer containers is to prevent accidental or intentional turning on of the module when a plug is not mated up with the receptacle. The other function is to automatically shut off the unit if someone accidentally or intentionally unplugs the mating plug without turning off the unit. Mechanical interlock socket outlets for reefer power connections receive considerable wear and tear during use. There is a need for more reliable interlock units for reefer power connections.

### SUMMARY OF THE INVENTION

A mechanical interlock socket outlet includes a female receptacle mounted to a face plate, a breaker box, a toggle switch for activating the breaker box, and an actuating rod for operating the toggle switch. The actuating rod extends through the face plate. A locking arm is provided for engaging the actuating rod to prevent the actuating rod from operating the toggle switch when the locking arm is in a first position, and for permitting the actuating rod to operate the toggle switch when the locking arm is in a second position. A safety release saddle plate is engaged to the actuating rod such that movement of one of the actuating rod and the saddle plate will cause movement of the other of the saddle plate and the actuating rod, the saddle plate having a locking arm release portion such that movement of the saddle plate will contact the locking arm and move the locking arm from the first, locked position to the second, unlocked position. Springs connected between the safety release saddle plate and the face plate. The springs are connected to a portion of the safety release saddle plate adjacent a top portion of the safety release saddle plate. The springs act to return the saddle plate to a locked position in which actuating rod moves the toggle switch to a locked position where the breaker box is deactivated. A push pin is provided. The push pin is contacted by a plug when the plug is inserted into the receptacle. The push pin contacts the safety release saddle plate to move the saddle plate and to cause the saddle plate to contact the locking arm and move the locking arm from the first, locked position to the second, unlocked position.

The actuating rod can have laterally extending pins. The pins contact the safety release saddle plate to move the safety release saddle plate when the actuating rod is moved, and to move the actuating rod when the safety release saddle plate is moved.

### BRIEF DESCRIPTION OF THE DRAWINGS

A fuller understanding of the present invention and the features and benefits thereof will be obtained upon review of the following detailed description together with the accompanying drawings, in which:

FIG. 1 is a front elevation of a reefer interlock unit for reefer power connection.

FIG. 2 is a right side elevation.

FIG. 3 is a top plan view.

FIG. 4 is a left side elevation.

FIG. 5 is a rear elevation.

FIG. 6 is a front elevation of a reefer interlock unit for reefer power connection when mated with an electrical plug.

FIG. 7 is a right side elevation.

FIG. 8 is a top plan view.

FIG. 9 is a left side elevation.

FIG. 10 is a rear elevation.

FIGS. 11A-C are specifications of a neon light according to one embodiment of the invention.

### DETAILED DESCRIPTION OF THE INVENTION

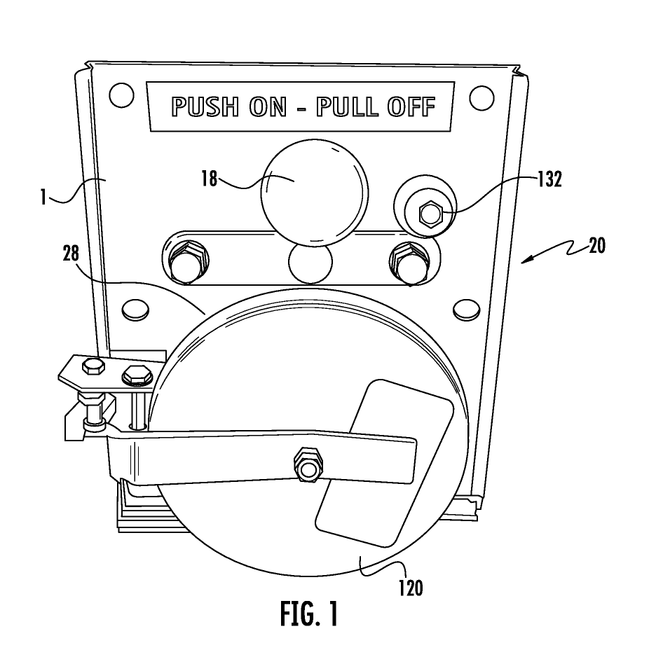

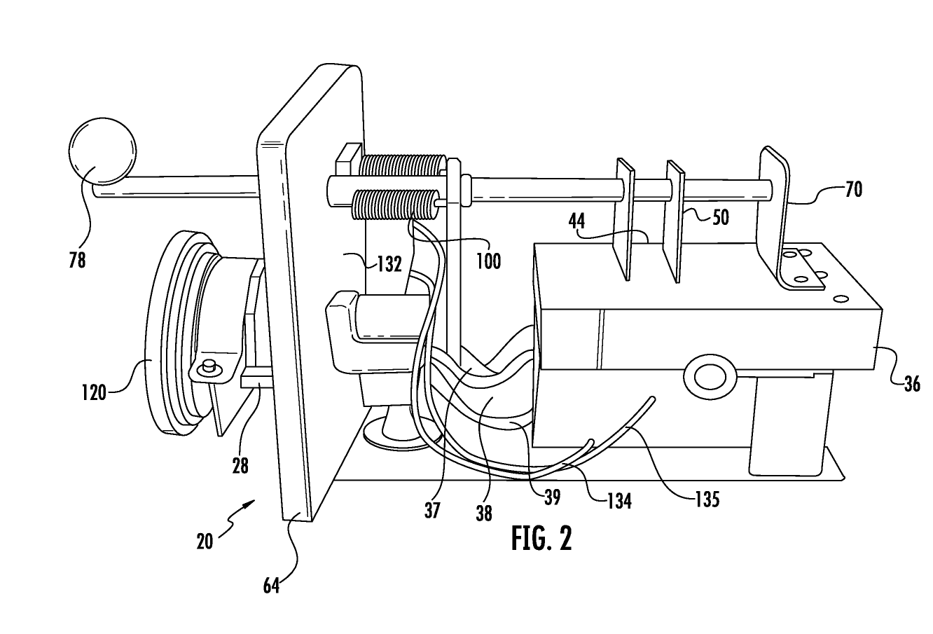

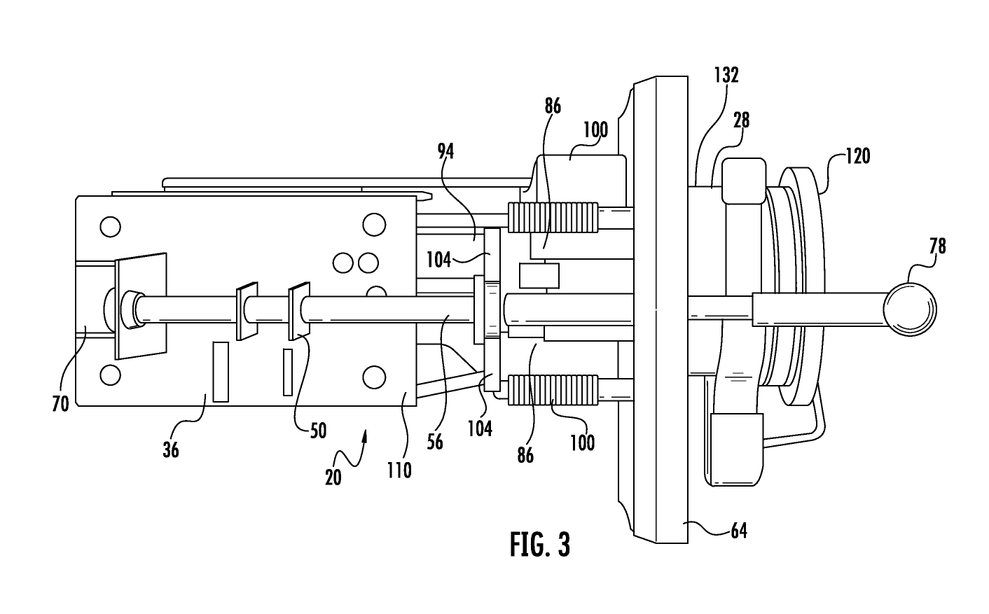

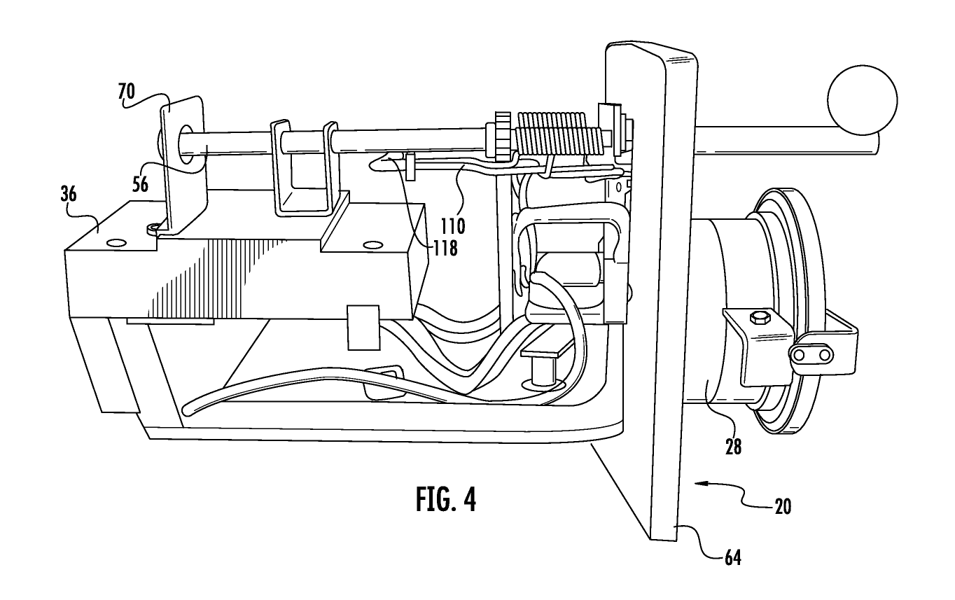

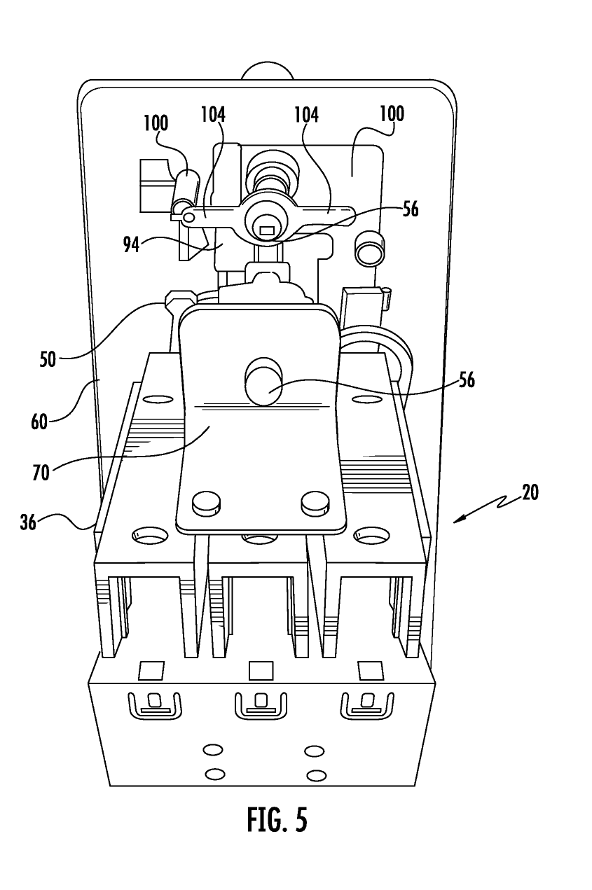

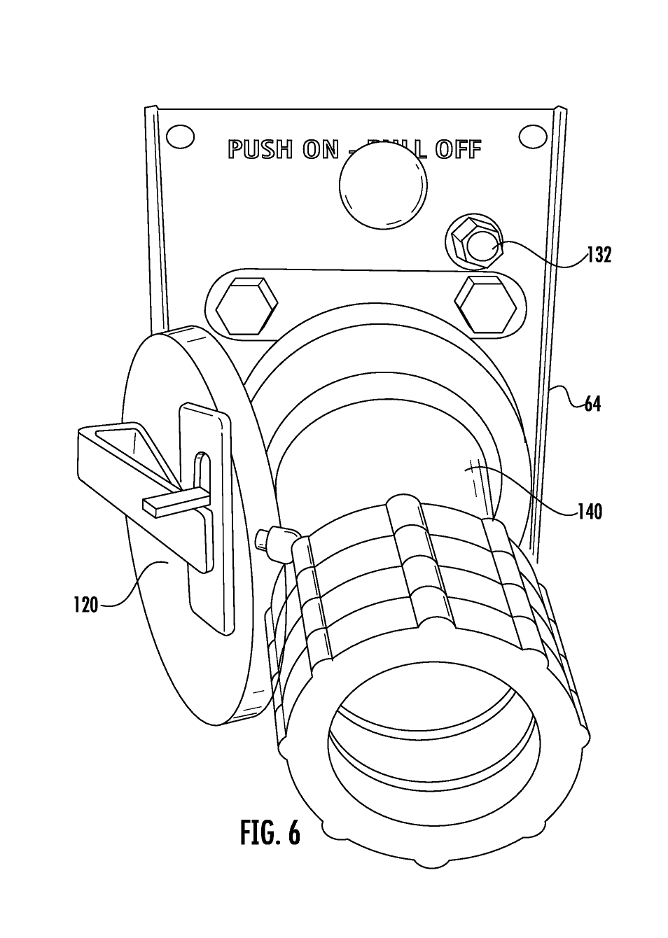

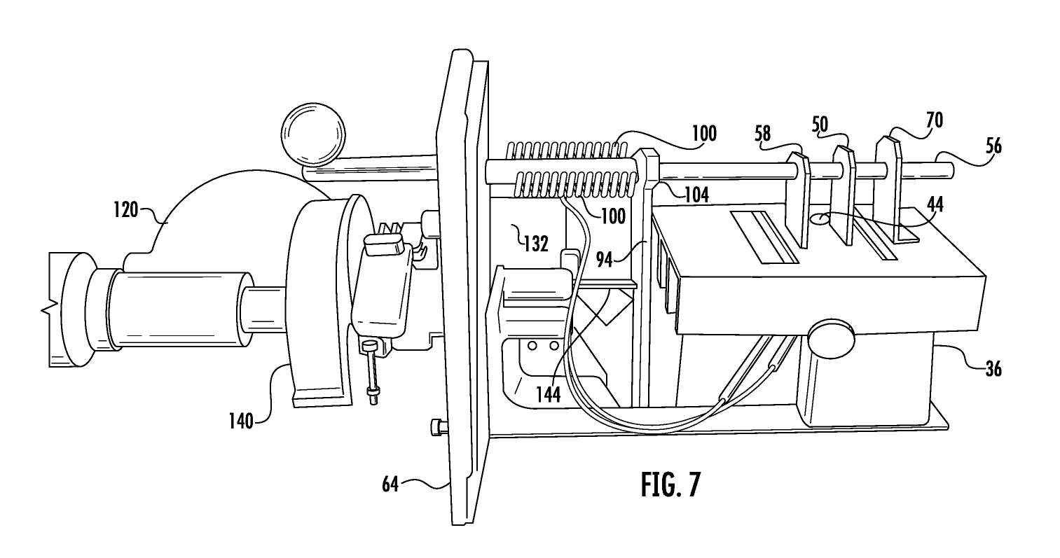

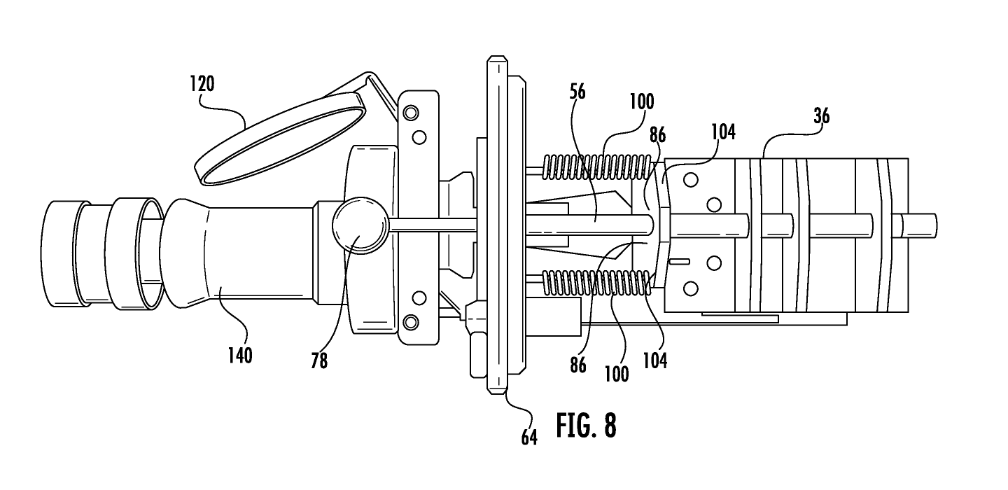

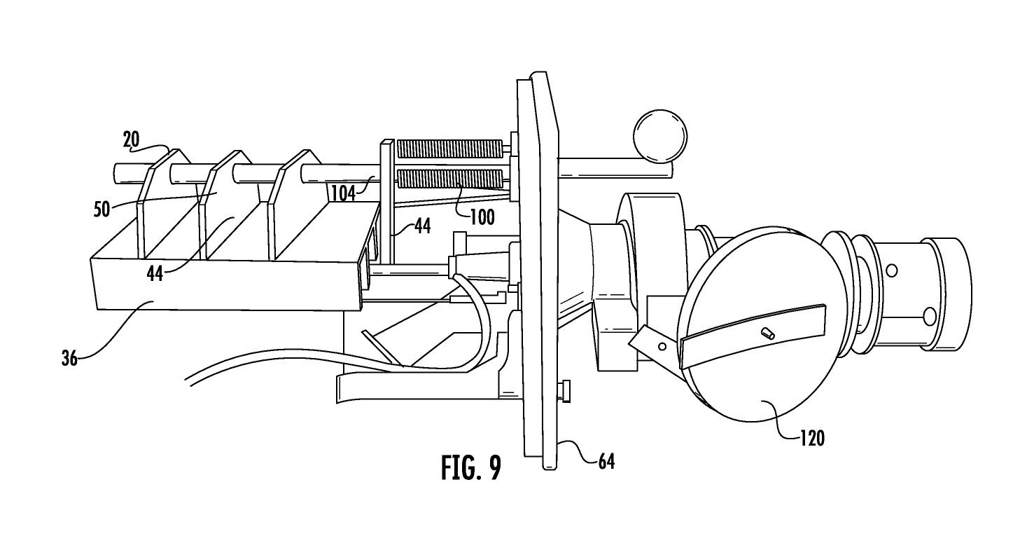

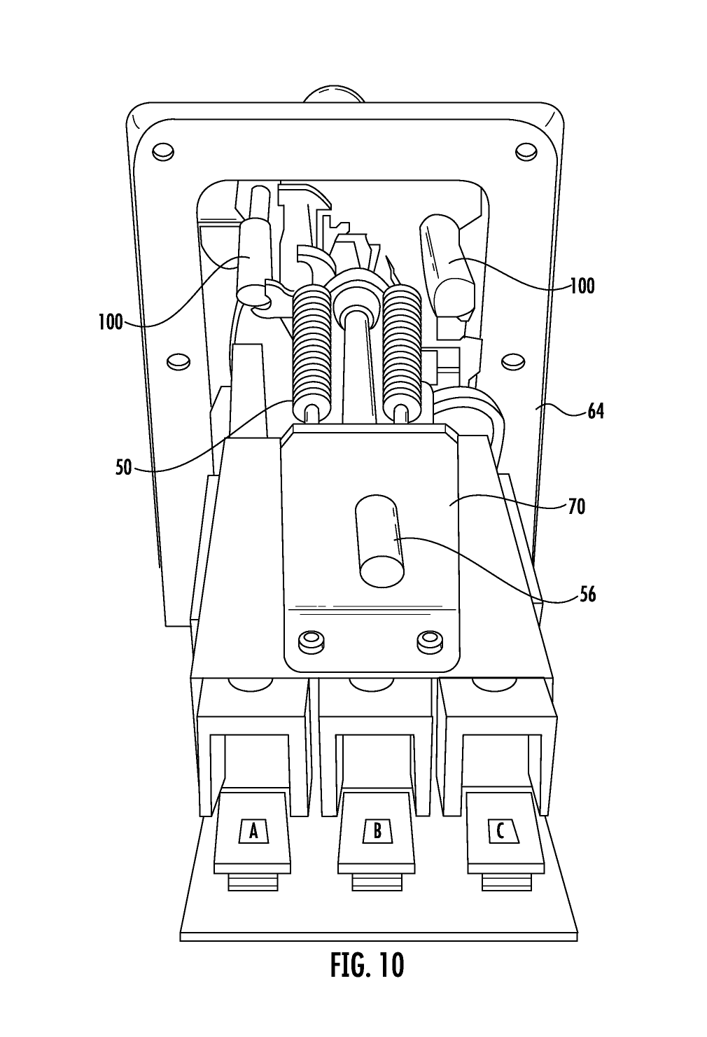

As shown in FIGS. 1-10, a mechanical interlock socket outlet 20 includes a female receptacle 28 and a breaker box 36. The breaker box 36 has a toggle switch 44 for activating the breaker box 36. A clasp 50 engages the switch 44 for purposes of activating and deactivating the breaker box 36. The clasp 50 is engaged to an actuating rod 56. The actuating rod extends through a face plate 64 and is secured in an end plate 70 that can be attached to the breaker box 36. Engagement pins 58 or other protrusions extend laterally outwardly from the actuating rod 56 to engage the clasp 50 such that movement of the actuating rod 56 moves the clasp 50 and thus activates or deactivates the switch 44 and breaker box 36. Power from the breaker box reaches the plug 28 through suitable connections such as electrical connection wires 37-39. A handle 78 is provided for gripping the actuating rod 56.

A locking arm 110 is secured to the plate 64 and engages a locking pin 112 on the actuating rod 56 to prevent movement of the actuating rod 56 toward the breaker box 36. Movement of the locking arm 110 as by pivoting will disengage the locking arm 110 from the locking pin 112 to permit such movement of the actuating rod 56 and activation of the breaker box 36.

The interlock unit is constructed with the ground pin in the receptacle (not shown) as the part that will engage or disengage the safety locking latch. If the unit is not mated with a plug the operator cannot turn on the unit. When a plug is mated with the receptacle ground safety pin then the operator can turn on the unit and give power to the receptacle and plug.

A safety release saddle plate 94 is engaged to the actuating rod 56 by suitable structure such as protrusions or pins 86. Movement of the actuating rod 56 will cause movement of the pins 86 which will contact and move the saddle plate 94. Safety springs 100 are mounted to a top portion 104 of the saddle plate 94. The safety springs act in two ways. The springs 100 will not allow the plug 140 to stay in the receptacle 28 unless the plugs locking collar is fully made up with the receptacle. If the plug 140 is removed without turning off the unit the safety springs 100 will automatically pull forward forcing the plug 140 out of the receptacle 28 and turning off the power to the unit.

The springs 100 act to return the saddle plate 94 to the locked position in which the breaker box 36 is deactivated. A push pin 144 mates with the ground pin of the plug such that when the plug is inserted into the outlet 28 the ground pin of the plug 140 engages the push pin 144 which moves the saddle plate 94. The saddle plate 94 engages the locking arm 110 to move it out of the way of the locking pin 112 on the actuating rod 56. This will permit the actuating rod 56 to be pushed toward the breaker box 36, moving the clasp 50 and throwing the switch 44.

The invention provides an interlock unit with reliable and smooth operation that will not flex during use when a plug 140 is inserted. The use of the pins 86 instead of flat surfaces on the actuating rod 56 as in prior designs prevents rubbing and binding. In line operation of the actuating rod 56 with the end plate or rear guide 70 eases insertion of the plug 140. The positioning of the springs 100 provides for more secure mounting of the springs 100, easier assembly of the springs 100 and the actuating rod 56, with less binding than in prior designs. There is level back and forth movement of the clasp or bracket 50, and the mounting of engagement pins 58 on either side of the clasp 50 provides greater strength to the clasp 50 and helps to limit flexing of this part. Horizontal mounting of the pins 86 insures that they remain in position. The invention requires less machining of the related parts than in some prior designs.

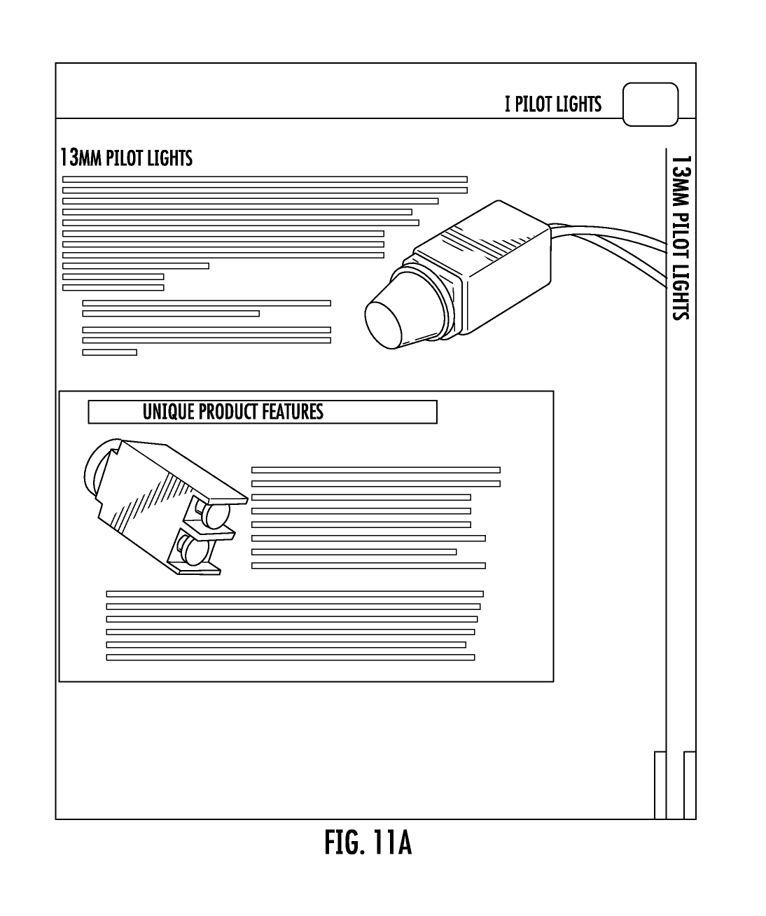

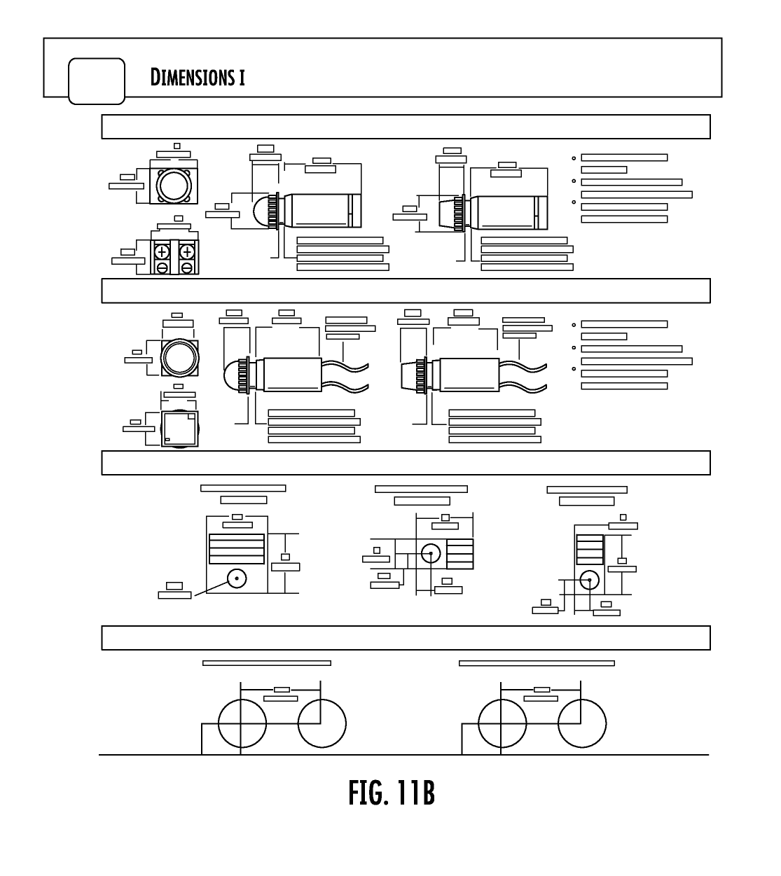

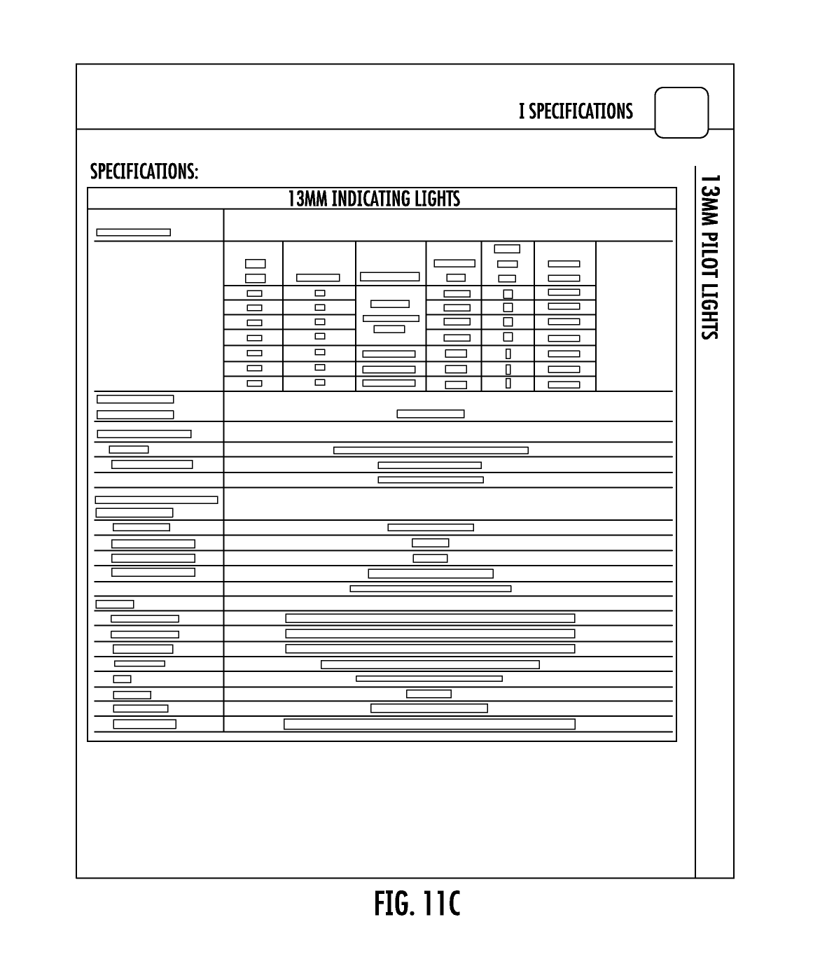

A long lasting neon safety light 132 can be provided. The neon light is rated 480V and has resistors mounted to it thereby eliminating the need for a step down transformer and micro switch. It is mounted to the load side of the breaker and goes on and off with the toggle switch 44 on the breaker box 36. It has a 25000 hour life, is already wired and can be easily installed or replaced. The safety light 132 can have electrical connections 134-135 to power the unit. Details of one such suitable neon light are shown in FIGS. 11A-C. The c 3 controls 13 mm pilot light is a 480V rated neon pilot light and is UL and CSA listed. It is also Type 4/4X as standard for watertight and corrosion resistance. They are available with wire lead or screw terminal. The use of this pilot light with the 32ROS-N eliminates the need for step down transformers and micro switches as required when using LED pilot lights. The installation of this unit and wiring directly to the load side of the module circuit breaker makes the breaker toggle switch the on off switch thereby eliminating micro switch and step down transformer from 480V. This is a change in the custom of using LED lights for pilot lights. A mounting hole is provided on the front of the module as shown on FIG. 11. The light is installed by mating the pilot light up with the dress ring/panel gasket, attaching the wires from the resistor unit on the back of the light to two wire lead pieces and wire then to line 1 & 3 and the light is ready for supplying on/off indicator. This light can also be installed at 240V for use in 30A 250V and 50A 250V interlocked modules, among others. It has very good resistance to shock and vibration for use on board container ships and generator sets attached to trailer chassis.

We claim:

1. A mechanical interlock socket outlet, comprising:
a female receptacle mounted to a face plate;
a breaker box;
a toggle switch for activating the breaker box;
an actuating rod for operating the toggle switch, the actuating rod extending through the face plate;
a locking arm for engaging the actuating rod to prevent the actuating rod from operating the toggle switch when the locking arm is in a first position, and for permitting the actuating rod to operate the toggle switch when the locking arm is in a second position;
a safety release saddle plate engaged to the actuating rod such that movement of one of the actuating rod and the saddle plate will cause movement of the other of the saddle plate and the actuating rod, the saddle plate having a locking arm release portion such that movement of the saddle plate will contact the locking arm and move the locking arm from the first, locked position to the second, unlocked position;
springs connected between the safety release saddle plate and the face plate, the springs being connected to a portion of the safety release saddle plate adjacent a top portion of the safety release saddle plate, the springs acting to return the saddle plate to a locked position in which actuating rod moves the toggle switch to a locked position where the breaker box is deactivated;
a push pin, the push pin being contacted by a plug when the plug is inserted into the receptacle, the push pin contacting the saddle plate to move the saddle plate to cause the saddle plate to contact the locking arm and move the locking arm from the first, locked position to the second, unlocked position.

2. The mechanical interlock socket outlet of claim 1, wherein the actuating rod comprises laterally extending pins, the pins contacting the safety release saddle plate to move the safety release saddle plate when the actuating rod is moved, and to move the actuating rod when the safety release saddle plate is moved.
